(19) United States
(12) Patent Application Publication
(10) Pub. No.: US 2026/0204295 A1
(43) Pub. Date: Jul. 16, 2026

(54) RECESSED BASE FOR A MAGNETIC STORAGE DEVICE

(71) Applicant: Western Digital Technologies, Inc., San Jose, CA (US)

(72) Inventors: Yuichi Arai, Fujisawa-shi (JP); Yoshiyuki Hirono, Fujisawa-shi (JP); Takashi Tomita, Fujisawa-shi (JP)

(21) Appl. No.: 19/025,802

(22) Filed: Jan. 16, 2025

(51) Int. Cl. G11B 33/02

(52) U.S. Cl. CPC G11B 33/02

(57) ABSTRACT

A base for a magnetic storage device includes a baseplate, sidewalls extending from the baseplate, and an interior cavity defined by the baseplate and the sidewalls. The baseplate includes an exterior surface and an interior surface opposite to the exterior surface. The interior surface at least partially defines the interior cavity. The interior surface includes a substantially planar surface and grooves formed in the substantially planar surface. A thickness of the baseplate varies. A minimum thickness of the baseplate is defined by at least one groove of the grooves.

### FIELD

This disclosure relates generally to magnetic storage devices, and more particularly to recessed bases for magnetic storage devices.

### BACKGROUND

Magnetic storage devices, such as hard disk drives (“HDDs”), are widely used to store digital data or electronic information for enterprise data processing systems, computer workstations, portable computing devices, digital audio players, digital video players, and the like. Generally, HDDs include read-write heads that help facilitate storage of data on magnetic disks. Each read-write head is supported on a suspension assembly. Some HDDs include a suspension assembly with a flexure.

### SUMMARY

A need exists for a magnetic storage device and a method of manufacture that help to reduce power loss that results from a resistance of gas between a disk and a base of the magnetic storage device as that disk rotates. The subject matter of the present application has been developed in response to the present state of magnetic storage devices, and in particular, in response to problems and needs in the art, such as those discussed above, that have not yet been fully solved by currently available magnetic storage devices. Accordingly, the examples of the present disclosure overcome at least some of the shortcomings of the prior art.

The following is a non-exhaustive list of examples, which may or may not be claimed, of the subject matter disclosed herein.

Disclosed herein is a base for a magnetic storage device. The base includes a baseplate, sidewalls extending from the baseplate, and an interior cavity defined by the baseplate and the sidewalls. The baseplate includes an exterior surface and an interior surface opposite to the exterior surface. The interior surface at least partially defines the interior cavity. The interior surface includes a substantially planar surface and grooves formed in the substantially planar surface. A thickness of the baseplate varies. A minimum thickness of the baseplate is defined by at least one groove of the grooves. The preceding subject matter of this paragraph characterizes example 1 of the present disclosure.

Each groove of the grooves has a substantially circular shape. The preceding subject matter of this paragraph characterizes example 2 of the present disclosure, wherein example 2 also includes the subject matter according to example 1, above.

A minimum thickness of the baseplate defined by the at least one groove of the grooves is not less than 20 percent of a maximum thickness of the baseplate. The preceding subject matter of this paragraph characterizes example 3 of the present disclosure, wherein example 3 also includes the subject matter according to any one of examples 1-2, above.

The grooves are equidistantly spaced. The preceding subject matter of this paragraph characterizes example 4 of the present disclosure, wherein example 4 also includes the subject matter according to any one of examples 1-3, above.

Also disclosed herein is a magnetic storage system. The magnetic storage system includes a quantity of disks configured to rotate about an axis and a base. The base includes a baseplate, sidewalls extending from the baseplate, and an interior cavity defined by the baseplate and the sidewalls and receiving the quantity of disks. The baseplate includes an exterior surface and an interior surface opposite to the exterior surface. The interior surface at least partially defines the interior cavity. The interior surface includes a substantially planar surface and grooves formed in the substantially planar surface. A thickness of the baseplate varies. A minimum thickness of the baseplate is defined by at least one groove of the grooves. The preceding subject matter of this paragraph characterizes example 5 of the present disclosure.

The grooves extend radially outward in a direction away from the axis. The preceding subject matter of this paragraph characterizes example 6 of the present disclosure, wherein example 6 also includes the subject matter according to example 5.

At least one groove of the grooves has a length that is not less than 20 percent and not more than 90 percent of a radius of each disk of the quantity of disks. The preceding subject matter of this paragraph characterizes example 7 of the present disclosure, wherein example 7 also includes the subject matter according to example 6.

An entirety of the grooves is confined within an outer perimeter of the disks. The preceding subject matter of this paragraph characterizes example 8 of the present disclosure, wherein example 8 also includes the subject matter according to examples 5-7, above.

Each groove of the grooves has a substantially conical shape. The grooves are arranged in a plurality of lines, each line extending radially outward away from the axis. The preceding subject matter of this paragraph characterizes example 9 of the present disclosure, wherein example 9 also includes the subject matter according to any one of examples 5-8, above.

The grooves of a first line of the plurality of lines are offset radially from the grooves of a second line of the plurality of lines, the second line being adjacent to the first line. The preceding subject matter of this paragraph characterizes example 10 of the present disclosure, wherein example 10 also includes the subject matter according to example 9.

Each groove of the grooves has a circular shape concentric with the quantity of disks. The preceding subject matter of this paragraph characterizes example 11 of the present disclosure, wherein example 11 also includes the subject matter according to any one of examples 5-10, above.

In a circumferential direction about the axis, a distance from the axis to each groove of the grooves changes. The preceding subject matter of this paragraph characterizes example 12 of the present disclosure, wherein example 12 also includes the subject matter according to any one of examples 5-11, above.

The disks are configured to rotate in a first direction and the distance increases in a circumferential direction opposite to the first direction. The preceding subject matter of this paragraph characterizes example 13 of the present disclosure, wherein example 13 also includes the subject matter according to example 12.

At least some of the grooves intersect a plane along which the axis lies. The preceding subject matter of this paragraph characterizes example 14 of the present disclosure, wherein example 14 also includes the subject matter according to examples 12-13, above.

A ratio of the quantity of disks to a quantity of the grooves is between, and inclusive of, 0.05 and 10. The preceding subject matter of this paragraph characterizes example 15 of the present disclosure, wherein example 15 encompasses examples 5-14, above.

The exterior surface is substantially planar and groove-less. The preceding subject matter of this paragraph characterizes example 16 of the present disclosure, wherein example 16 also includes examples 5-15, above.

The base has a monolithic, one-piece, and seamless construction. The preceding subject matter of this paragraph characterizes example 17 of the present disclosure, wherein example 17 also includes examples 5-16, above.

A maximum distance between a bottom disk of the quantity of disks, closest to the baseplate, and the interior surface is not less than 0.5 mm and not greater than 2.5 mm. The preceding subject matter of this paragraph characterizes example 18 of the present disclosure, wherein example 18 also includes examples 5-17, above.

Each groove of the grooves defines a recessed portion of the baseplate. A distance between a bottom disk of the quantity of disks, closest to the baseplate, and the interior surface at the recessed portion is greater than a distance between the bottom disk and any other portion of the interior surface. The preceding subject matter of this paragraph characterizes example 19 of the present disclosure, wherein example 19 also includes examples 5-18, above.

Further disclosed herein is a magnetic storage system. The magnetic storage system includes a quantity of disks configured to rotate about an axis and a base. The base includes a baseplate, sidewalls extending from the baseplate, and an interior cavity defined by the baseplate and the sidewalls and receiving the quantity of disks. The baseplate includes an exterior surface and an interior surface opposite to the exterior surface. The interior surface at least partially defines the interior cavity. The interior surface includes a substantially planar surface and a means of varying a thickness of the baseplate such that a minimum thickness of the baseplate is defined by the means of varying the thickness. The preceding subject matter of this paragraph characterizes example 20 of the present disclosure.

The described features, structures, advantages, and/or characteristics of the subject matter of the present disclosure may be combined in any suitable manner in one or more examples and/or implementations. In the following description, numerous specific details are provided to impart a thorough understanding of examples of the subject matter of the present disclosure. One skilled in the relevant art will recognize that the subject matter of the present disclosure may be practiced without one or more of the specific features, details, components, materials, and/or methods of a particular example or implementation. In other instances, additional features and advantages may be recognized in certain examples and/or implementations that may not be present in all examples or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims or may be learned by the practice of the subject matter as set forth hereinafter.

### BRIEF DESCRIPTION OF THE DRAWINGS

In order that the advantages of the disclosure will be readily understood, a more particular description of the disclosure briefly described above will be rendered by reference to specific examples that are illustrated in the appended drawings. Understanding that these drawings depict only typical examples of the disclosure and are not therefore to be considered to be limiting of its scope, the subject matter of the present application will be described and explained with additional specificity and detail through the use of the accompanying drawings, in which:

FIG. 1A is a perspective view of a magnetic storage device, according to one or more examples of the present disclosure;

FIG. 1B is a cross-sectional side elevation view of a magnetic storage device, taken along the plane A of FIG. 1A, according to one or more examples of the present disclosure;

FIG. 1C is a close-up, cross-sectional side elevation view of a magnetic storage device, taken along the plane A of FIG. 1A, according to one or more examples of the present disclosure;

FIG. 2A is a top plan view of a base of a magnetic storage device, according to one or more examples of the present disclosure;

FIG. 2B is a cross-sectional side elevation view of a base of a magnetic storage device, taken along the plane B of FIG. 2A, according to one or more examples of the present disclosure;

FIG. 3A is a top plan view of a base of a magnetic storage device having a circular groove, according to one or more examples of the present disclosure;

FIG. 3B is a cross-sectional side elevation view of a base of a magnetic storage device, taken along the plane B of FIG. 3A, according to one or more examples of the present disclosure;

FIG. 4A is a top plan view of a base of a magnetic storage device having a plurality of grooves, according to one or more examples of the present disclosure;

FIG. 4B is a cross-sectional side elevation view of a base of a magnetic storage device, taken along the plane B of FIG. 4A, according to one or more examples of the present disclosure; and

FIG. 5 is a top plan view of a base of a magnetic storage device having a curved groove, according to one or more examples of the present disclosure.

### DETAILED DESCRIPTION

Reference throughout this specification to “one example,” “an example,” or similar language means that a particular feature, structure, or characteristic described in connection with the example is included in at least one example of the present disclosure. Appearances of the phrases “in one example,” “in an example,” and similar language throughout this specification may, but do not necessarily, all refer to the same example. Similarly, the use of the term “implementation” means an implementation having a particular feature, structure, or characteristic described in connection with one or more examples of the present disclosure. However, absent an express correlation to indicate otherwise, an implementation may be associated with one or more examples.

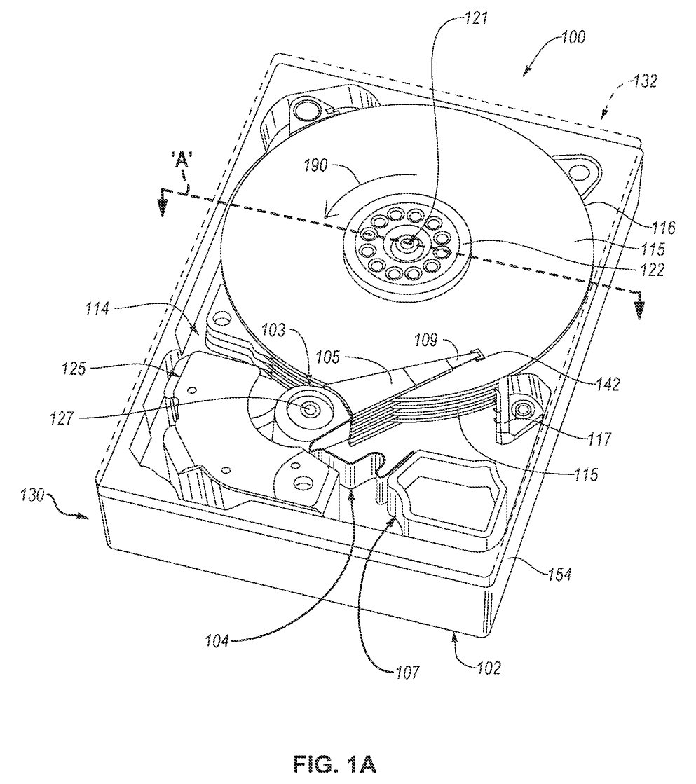

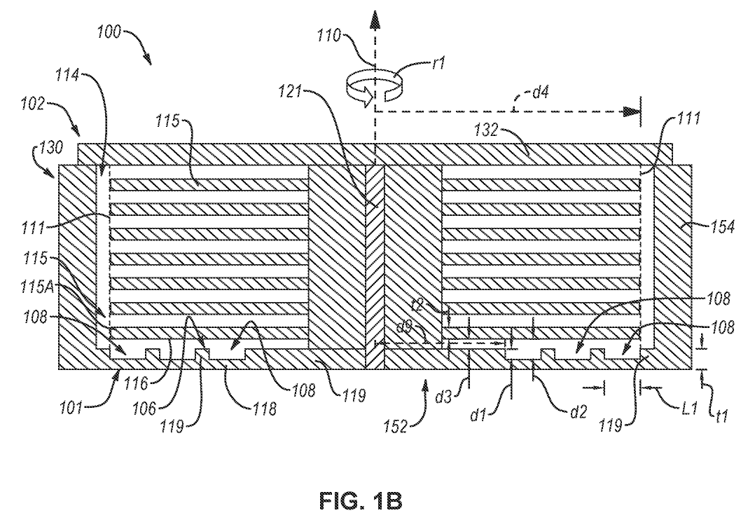

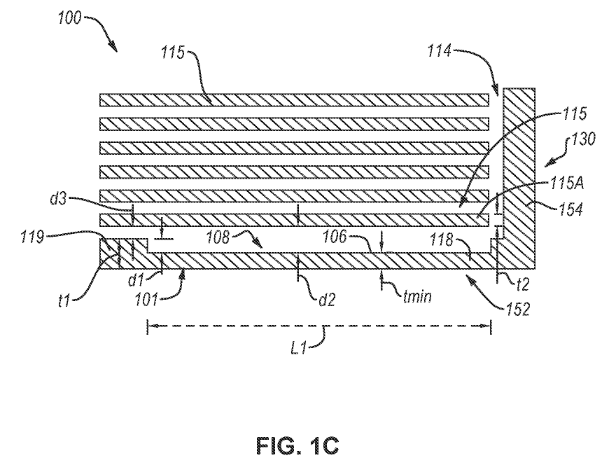

Referring to FIG. 1A, a magnetic storage device 100, according to one example, is depicted as a hard disk drive (HDD). However, in other examples, the magnetic storage device 100 can be any of various magnetic storage devices without departing from the essence of the subject matter of the present disclosure. The magnetic storage device 100 includes a housing 102 that seals or encloses an interior cavity 114 defined within the housing. The housing 102 includes a base 130 and a cover 132 (shown in dashed lines so as not to obscure internal features of the magnetic storage device 100 within the interior cavity 114 of the housing 102). The cover 132 is coupled to the base 130 to enclose the interior cavity 114 from the environment exterior to the housing 102. In some implementations, a seal or gasket is positioned between the base 130 and the cover 132 to promote a seal between the base 130 and the cover 132. In some examples, the base 130 is made of a metallic material, such as stainless steel or aluminum.

Referring to FIGS. 1A-5, in some examples, the base 130 includes a baseplate 152 and sidewalls 154 extending from the baseplate 152. In one or more examples, the interior cavity 114 is defined by the baseplate 152 and the sidewalls 154. In some examples, the baseplate 152 includes an exterior surface 101 and an interior surface 106 opposite to the exterior surface 101. The interior surface 106 at least partially defines the interior cavity 114.

The magnetic storage device 100 includes various features located within the interior cavity 114 of the housing 102. Referring to FIG. 1A, in some examples, the magnetic storage device 100 includes a carriage 103, disks 115, a spindle motor 121, and a voice coil motor (VCM) 125 within the interior cavity 114. Referring again to FIG. 1A, the carriage 103 includes a head stack assembly, which includes a plurality of carriage arms 105 and at least one head-gimbal assembly 109 (e.g., suspension), coupled to the distal tip of each carriage arm of the plurality of carriage arms 105. Each head-gimbal assembly 109 includes a suspension assembly and a slider 142. The slider 142 includes at least one read-write head coupled to (e.g., embedded in) a housing of the slider 142. Although the magnetic storage device 100 in FIG. 1A is shown to have five carriage arms 105 and four disks 115, in other examples, the magnetic storage device 100 can have fewer or more than five carriage arms 105 or fewer or more than four disks 115. In one example, each side of each carriage arm 105 facing a disk 115 has a head-gimbal assembly 109 (e.g., each one of bottom and top carriage arms 105 can have one head-gimbal assembly 109, and each one of middle carriage arms 105, between the bottom and top carriage arms 105, can have two head-gimbal assemblies 109). Similarly, although the magnetic storage device 100 is shown to have one spindle motor 121 and one VCM 125, in other examples, the magnetic storage device 100 can have any number of spindle motors 121 and VCMs 125.

The spindle motor 121 is coupled to the base 130. In some examples, the spindle motor 121 is coupled to the base 130 at the baseplate 152. Generally, the spindle motor 121 includes a stationary portion non-movably fixed relative to the base 130 and a spindle 122 that is rotatable relative to the stationary portion and the base 130. Accordingly, the spindle 122 of the spindle motor 121 can be considered to be part of or integral with the spindle motor. Generally, the spindle motor 121 is operable to rotate the spindle 122 relative to the base 130. The disks 115, or platters, are co-rotatably fixed to the spindle 122 of the spindle motor 121 via respective hubs, which are co-rotatably secured to respective disks 115 and the spindle 122. As the spindle 122 of the spindle motor 121 rotates, the disks 115 correspondingly rotate. In this manner, the spindle 122 of the spindle motor 121 defines a rotational axis of each disk 115. The spindle motor 121 can be operatively controlled to rotate the disks 115, in a rotational direction 190, a controlled amount at a controlled rate.

Referring to FIGS. 1A-1B, each one of the disks 115 may be any of various types of magnetic recording media. Generally, in one example, each disk 115 includes a substrate and a magnetic material applied directly or indirectly onto the substrate. For example, the magnetic material of the disks 115 may be conventional granular magnetic recording disks or wafers that have magnetic layer bits with multiple magnetic grains on each bit. In granular magnetic media, all of the bits are co-planar, and the surface 116 of the disk is substantially smooth and continuous. In one example, each bit has a magnetic dipole moment that can either have an in-plane (longitudinal) orientation or an out-of-plane (perpendicular) orientation.

As the disks 115 rotate in a read-write mode, the VCM 125 electromagnetically engages voice coils of the carriage arms 105 to rotate the carriage arms 105, and the head-gimbal assemblies 109, which are coupled to the carriage arms 105, relative to the disks 115 in a rotational direction along a plane parallel to read-write surfaces of the disks 115. The carriage arms 105 can be rotated to position the read-write head of the head-gimbal assemblies 109 over a specified radial area of the read-write surface 116 of a corresponding disk 115 for read and/or write operations. The VCM 125 is fixed to the base 130 in engagement with the voice coils of the carriage arms 105, which are rotatably coupled to the base 130 via a spindle 127 extending through the carriage 103. Generally, the spindle 127 defines a rotational axis about which the carriage arms 105 rotate when actuated by the VCM 125.

The carriage arms 105 are non-movably fixed to (e.g., integrally formed as a one-piece unitary monolithic body with) and extend away from a base of the carriage 103 in a spaced-apart manner relative to each other. In some implementations, the carriage arms 105 are spaced equi-distantly apart from each other and extend parallel relative to each other. A respective one of the disks 115 is positioned between adjacent carriage arms 105. In an idle mode (e.g., when read-write operations are not being performed), the VCM 125 is actuated to rotate the carriage arms 105, in a radially outward direction relative to the disks 115, such that the head-gimbal assemblies 109 are parked or unloaded onto a ramp support 117 secured to the base 130.

The read-write head embedded in the slider 142 includes at least one read transducer and at least one write transducer. The read transducer is configured to detect magnetic properties (e.g., magnetic bit patterns) of a disk 115 and convert the magnetic properties into an electrical signal. In contrast, the write transducer changes the magnetic properties of a disk 115 responsive to an electrical signal. For each head-gimbal assembly 109, the electrical signals are transmitted from and to the read-write head via electrical traces or lines formed in or coupled to the slider 142 and the flexure. The electrical traces of the slider 142 and the flexure are electrically interconnected (e.g., via solder weldments that electrically connect corresponding electrical contact pads (and corresponding electrical traces) of the slider 142 and the flexure) to facilitate transmission of electrical signals between the read-write head and a flex connector 104 of the magnetic storage device 100. The flex connector 104 is in communication with a control module 107 of the magnetic storage device 100 (see, e.g., FIG. 1A). The control module 107 is configured to process the electrical signals and facilitate communication of the electrical signals between the magnetic storage device 100 and one or more external computing devices. Generally, the control module includes software, firmware, and/or hardware used to control operation of the various components of the magnetic storage device 100. The control module may include a printed circuit board on or in which the hardware is mounted.

FIGS. 1B-1C are cross-sectional side elevation views of the base 130 of the magnetic storage device 100, taken along the plane A of FIG. 1A. Referring to FIGS. 1B-1C, the disks 115 are displaced from the interior surface 106. As the disks 115 rotate about the axis 110, they can dissipate energy as they encounter resistance, such as air resistance or resistance between the disks 115 and gas (e.g., air or helium). The rotation of the disks 115 can create air currents, leading to friction between the disks 115 and the gas within the cavity 114, thus resulting in power loss. This power loss can contribute to excess heat generated within the magnetic storage device 100 and can reduce the overall efficiency and performance of the magnetic storage device 100. In some examples, increasing a gap between the interior surface 106 and the adjacent disk 115A can help to reduce this power loss. However, decreasing a maximum thickness t1 of the baseplate 152 can decrease the stiffness of the baseplate 152 and, consequentially, the resistance of the magnetic storage device 100 to shock and vibrations. Examples of the present disclosure include magnetic storage devices 100 with grooves 108 formed in the interior surface 106 that vary the thickness of the baseplate 152 and thus can help to reduce power loss, occurring due to gas resistance between the disks 115 and the interior surface 106, while maintaining stiffness of the baseplate 152.

Referring to FIGS. 1B-1C, 2B, 3B, and 4B, in some examples, the interior surface 106 includes a substantially planar surface in which the grooves 108 are formed. In some examples, at least one of the grooves 108 defines a minimum thickness tmin of the baseplate 152 (see, e.g., FIG. 1C). In other words, a thickness of the baseplate 152 is at a minimum where the groove(s) 108 are located (e.g., the minimum thickness tmin is equal to a distance between a bottommost surface of the groove(s) 108 and the exterior surface 101). The distance d2 between the interior surface 106 and a surface 116 of the disk 115A adjacent (i.e., nearest) to the interior surface 106 is maximized at the groove 108. The groove 108 is formed, in some examples, by recessing the interior surface 106 away from the disk 115A. In some examples, each one of the grooves 108 defines a recessed portion 118 of the baseplate 152. The baseplate 152 includes one or more non-recessed portions 119 adjacent to each recessed portion 118. At least one of the non-recessed portions 119 defines a maximum thickness t1 of the baseplate 152.

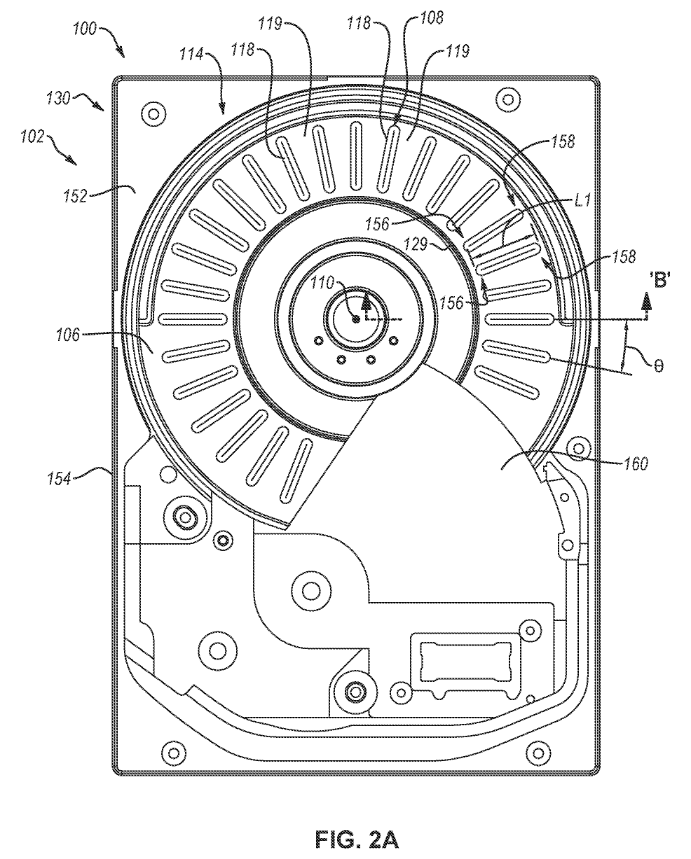

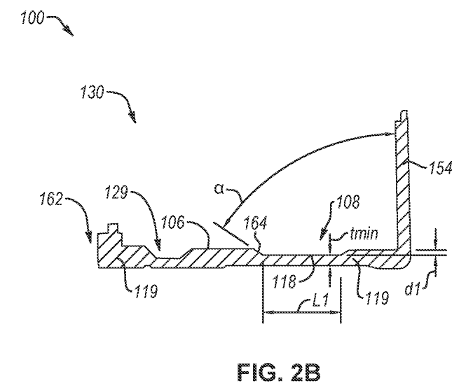

Referring to FIGS. 1B-1C, 2A, 3A, 4A, and 5A, in some examples, an entirety of each groove 108 is confined within an outer perimeter 111 of the disks 115. Each one of the grooves 108 extends from a first end 156 to a second end 158 (see, e.g., FIG. 2A). Accordingly, both the first end 156 and the second end 158 of each groove 108 are within the outer perimeter 111 in certain examples. In some examples, an area of the baseplate 152 within an outer perimeter 111 of the disks 115 includes multiple grooves 108 on either side of the axis 110. The baseplate 152 includes multiple recessed portions 118 and non-recessed portions 119 on either side of the axis 110, but within the outer perimeter 111.

Referring to FIG. 1B, in some examples, the interior surface 106 extends substantially parallel to a disk 115 surface in both the recessed portions 118 (e.g., bottommost surface) and the non-recessed portions 119 (e.g., planar portions between grooves). In a radially inward direction towards the axis 110, a thickness of the baseplate 152 decreases and is at a minimum (i.e., tmin) where any non-recessed portion 119 meets an adjacent recessed portion 118. In some examples, the baseplate 152 is coupled to the sidewalls 154 at a non-recessed portion 119.

Referring to FIGS. 2A, 3A, 4A, and 5A, in some examples, a portion 160 of the baseplate 152, over which the carriage arms 105 move, does not include any grooves 108. The portion 160 interrupts a groove 108 pattern. According to some examples, the thickness of the baseplate 152 in the portion 160 is less than the thickness t1 of the non-recessed portions 119. In at least one example, the thickness of the baseplate 152 in the portion 160 is less than the minimum thickness tmin described herein. In some examples, baseplate 152 height is lower in the portion 160.

In some examples, to help maintain the minimum thickness tmin of the baseplate 152, while increasing the maximum distance d2 between the disk 115 and the interior surface 106, the exterior surface 101 is substantially planar and substantially groove-less. Accordingly, the portion of the exterior surface 101 opposite to the groove 108 does not include a groove. In some examples, the exterior surface 101 is substantially parallel to a surface of one of the disks 115.

In some examples, a minimum thickness tmin of the baseplate 152 defined by the groove 108 is not less than 50 percent of a maximum thickness t1 of the baseplate 152. In one example, the maximum thickness t1 is a thickness of a non-recessed portion 119 adjacent to the recessed portion 118. In some examples, the minimum thickness tmin is not less than 40 percent of a maximum thickness t1 of the baseplate 152. In some examples, the minimum thickness tmin is not less than 20 percent of a maximum thickness t1 of the baseplate 152. In one or more examples, the minimum thickness tminis not greater than 80 percent of the maximum thickness t1. In yet certain examples, the minimum thickness tmin is between, and inclusive of, 60 percent of the maximum thickness t1 and 80 percent of the maximum thickness t1. In some examples, the minimum thickness tmin is between, and inclusive of, 65 percent of the maximum thickness t1 and 75 percent of the maximum thickness t1. According to at least one example, the maximum thickness t1 is between, and inclusive of, 1.5 millimeters (“mm”) and 3.5 mm.

In some examples, a difference between the distance d3 (between the disk 115 and a non-recessed portion 119 of the interior surface 106) and a distance d2 (between the disk 115 and a recessed portion 118 adjacent to the non-recessed portion 119) defines a groove depth d1. The groove depth d1 can also be defined as a difference between the maximum thickness t1 and the minimum thickness tmin when the portion of the baseplate 152 immediately adjacent the groove 108 defines the maximum thickness t1 and the groove 108 defines the minimum thickness tmin. In some examples, the groove depth d1 is constant through the length L1 of the groove 108. In some examples, the groove depth d1 is approximately 0.7 millimeters (“mm”). In some examples, the groove depth d1 is between, and inclusive of, 0.3 mm and 1.1 mm. In some examples, the groove depth d1 is approximately 0.5 mm. In some examples, the groove depth d1 is approximately equal to the distance d3 between the non-recessed portion 119 of the interior surface 106 and the disk 115. In some alternative examples, the groove depth d1 is variable through the length L1 of at least one of the grooves 108.

In various examples, a maximum distance d2 (between a bottom disk 115 closest to the baseplate 152 and the interior surface 106 at the recessed portion 118) is greater than a distance d3 (between the bottom disk 115 and any other portion of the interior surface 106, such as a non-recessed portion 119). In some examples, the distance d2 varies within the groove 108. In other examples, the distance d2 remains constant along the length L1 of the groove 108. In some examples, the distance d3 between the disk 115 and the non-recessed portion 119 varies within the outer perimeter 111 of the disk 115. In other examples, the distance d3 between the disk 115 and the non-recessed portion 119 is constant within the outer perimeter 111. In some examples, the distance d3 between the disk 115 and the non-recessed portion 119 is not greater than the depth d1 of the groove 108.

In some examples, the maximum distance d2 between the bottom disk 115A and the interior surface 106 is approximately 1 mm. In some examples, the maximum distance d2 is not greater than 2.5 mm. In some examples, the maximum distance d2 is not greater than the depth d1 of the groove 108. In some examples, the maximum distance d2 is greater than a thickness t2 of the disk 115.

In some examples, the minimum thickness tmin is sufficient to help maintain the stiffness of the baseplate 152 in the recessed portions 118. In one or more examples, the stiffness of the baseplate 152 in the recessed portions 118 is greater than or equal to 1100 Newtons per millimeter (“N/mm”). In some examples, the stiffness in the recessed portions 118 is greater than or equal to 1150 N/mm. In some examples, the stiffness in the recessed portions 118 is not less than 95 percent of a stiffness of the baseplate 152 in the non-recessed portions 119. In some examples, the stiffness in the recessed portion 118 is between, and inclusive of, 95 percent and 99 percent of a stiffness of the baseplate 152 in an adjacent non-recessed portion 119. In some examples, the stiffness in the recessed portion 118 is between, and inclusive of, 95.1 percent and 98 percent of the stiffness in an adjacent, non-recessed portion 119.

In some examples, the baseplate 152 has a monolithic, one-piece, and seamless construction. The base 130, in various examples, also has a monolithic, one-piece, and seamless construction. In such examples, the recessed portions 118 and non-recessed portions 119 of the baseplate 152 are of a monolithic construction. A non-recessed portion 119 is connected to the spindle motor 121.

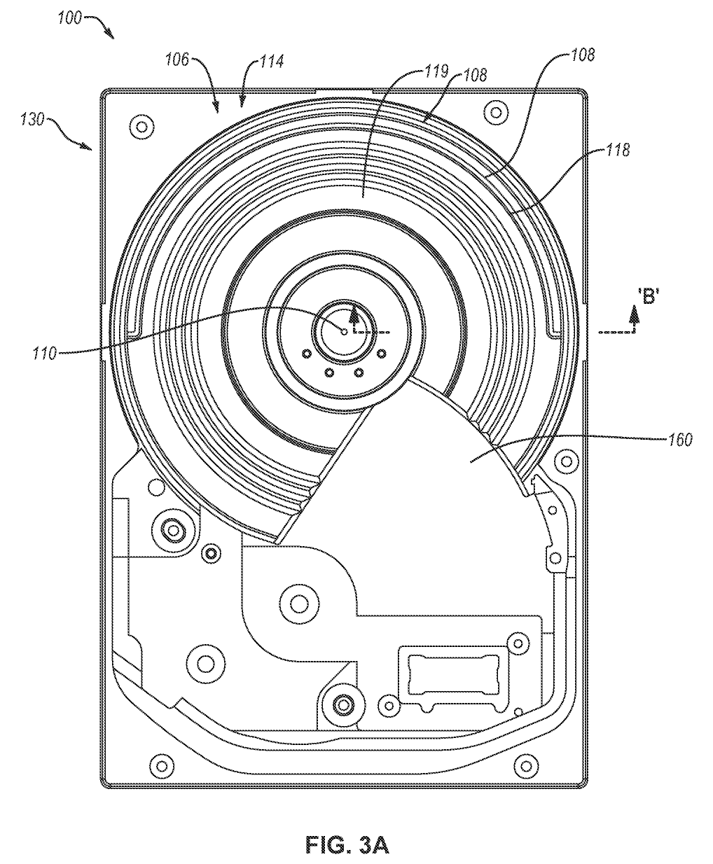

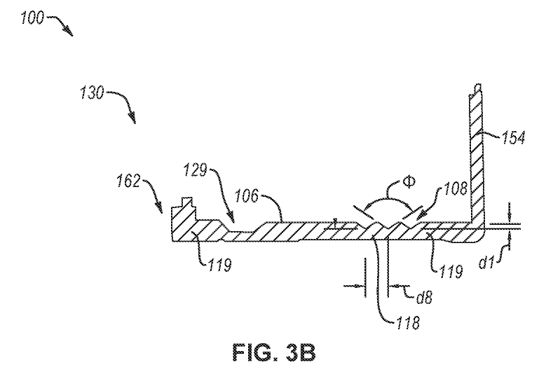

Referring to FIGS. 2A, 3A, 4A, and 5A, in some examples, all of the grooves 108 or at least a subset of the grooves 108 are equidistantly spaced. As shown in FIG. 2A, in some examples, each one of the grooves 108 is equally spaced circumferentially about the axis 110 relative to adjacent grooves. An angle θ defined between adjacent grooves 108 can be equal for each pair of adjacent grooves 108. Referring to FIGS. 3A-B, in some examples, at least some of the grooves 108 are equidistantly spaced in a radial direction that extends outward from the axis 110. In some examples, only a subset of the grooves 108 are equidistantly spaced.

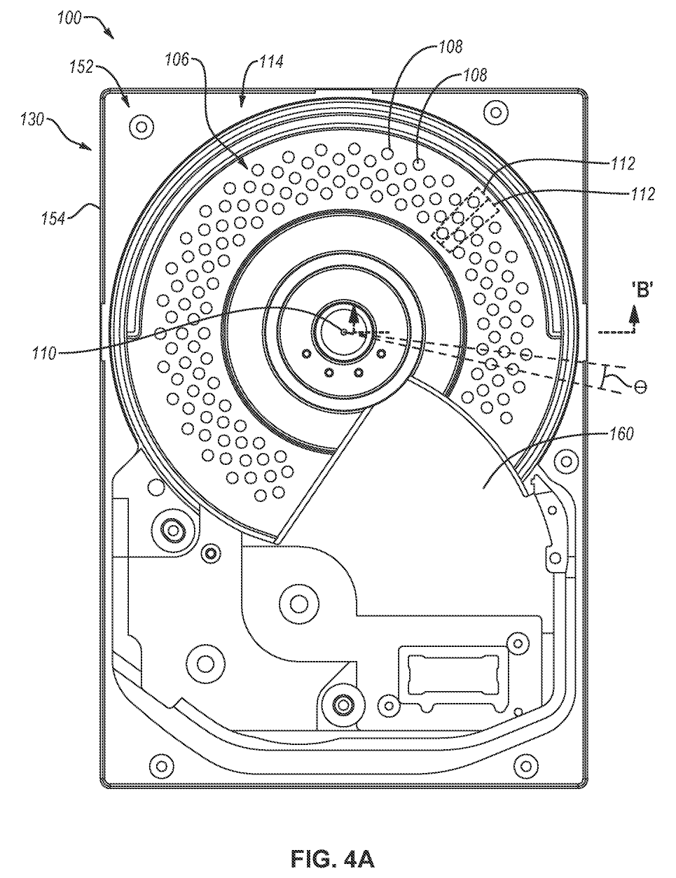

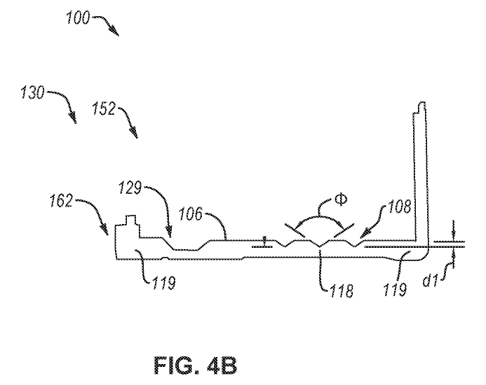

Referring to FIG. 4A, in some examples, the grooves 108 arranged in a particular line 112 are equidistantly spaced in the radial direction extending outward from the axis 110. In various examples, the lines 112 in which the grooves 108 are arranged are equidistantly spaced from each other in a circumferential direction. In some examples, the grooves 108 are arranged in concentric circles of grooves 108 equidistantly spaced apart from each other. Accordingly, in certain examples, the grooves 108 can be equidistantly spaced in both the radial and circumferential directions.

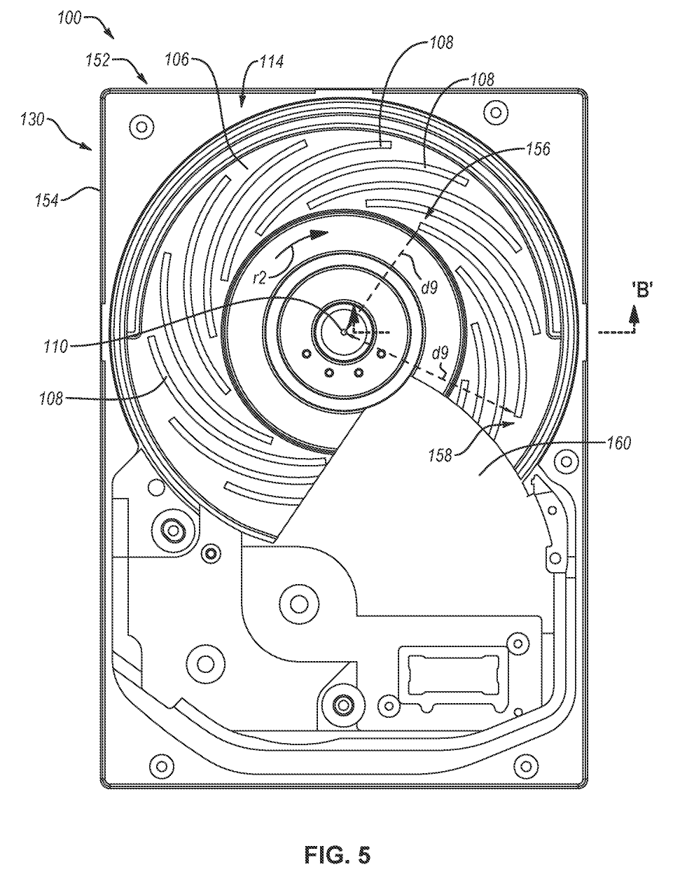

Referring to FIG. 3A, in some examples, equidistantly spaced grooves 108 are equidistantly spaced along an entirety of the groove 108. Although not illustrated in the Figures, in some examples, the grooves 108 are equidistantly spaced at a first groove end 156 but non-equidistantly spaced at a second groove end 158 opposite to the first groove end 156. Referring to FIGS. 2A and 5, in some examples, a distance between adjacent grooves 108, in the circumferential direction, varies along the length L1 of the groove 108. A distance, in a circumferential direction, between first ends 156 of adjacent grooves 108 is less than a distance, in a circumferential direction, between second ends 158 of adjacent grooves 108. The second ends 158 are opposite to the first ends 156.

Referring to FIGS. 2A-2B, in some examples, the grooves 108 extend radially outward in a radial direction away from the axis 110. These grooves 108 can be elongated grooves. Each groove is substantially perpendicular to the axis 110. Moreover, each groove 108 is substantially parallel to a radius d4 of the disks 115. Referring to FIGS. 1B-1C and 2A-2B, in some examples, at least one groove 108 has a length L1 that is not less than 20 percent and not more than 90 percent of a radius d4 of each one of the quantity of disks 115. In some examples, the groove length L1 is approximately 25 percent of the radius d4 of the disks 115. In some examples, the groove length L1 is between, and inclusive of, 10 mm and 15 mm.

FIG. 2B illustrates a cross-sectional side elevation view of the base 130, taken along the plane ‘B’ of FIG. 2A. Referring to FIG. 2B, in some examples, the baseplate 152 includes a gap. In some examples, the groove 108 extends along the length L1 between the gap and the sidewall 154, or between the gap and the outer perimeter 111 of the disks 115. In various examples, the interior surface 106 includes a circular groove 129 concentric with the axis 110. The circular groove 129 is between the gap and radial groove 108 in a radial direction extending outward from the axis 110.

In some examples, the angle α of the interior surface 106 with respect to the sidewall 154 and/or a direction substantially parallel to the axis 110 is approximately 90 degrees at the non-recessed portion 119 and at the recessed portion 118, and is less than 90 degrees at a sloped portion 164 connecting a recessed portion 118 and an adjacent, non-recessed portion 119. In some examples, the angle α is approximately 60 degrees.

In some examples, a distance between a gap and the groove 108 is greater than the length L1 of the groove 108. In some examples, the length L1 of the groove 108 is less than 70 percent of that distance. In one or more examples, the length L1 is between, and inclusive of, 10 percent and 50 percent of that distance.

Referring to FIGS. 2B, 3B, and 4B, in some examples, a height of a baseplate 152 varies within the base 130. In some examples, the depth d1 of the groove 108 is between, and inclusive of, 1.9 percent and 5.7 percent of a distance, in a direction substantially parallel to the sidewall 154, between an uppermost portion of the interior surface 106 and the recessed portion 118.

Referring to FIGS. 3A-3B, in some examples, at least one groove 108 is substantially circular in shape. Accordingly, each one of the grooves 108 can have a circular shape concentric with the quantity of disks 115. In such examples, the axis 110 defines a center point of a circle formed by at least one of the grooves 108. In some examples, a circular groove 108, having one radius, is concentric with another circular groove 108, having a different radius.

FIG. 3B is a cross-sectional side view of the base 130 taken along the plane ‘B’ of FIG. 3A. Referring to FIG. 3B, in some examples, the interior surface 106 includes a first circular groove 129 concentric with the axis 110 and located between a gap and an outer groove 108 in a radial direction extending outward from the axis 110. The outer groove 108 is a groove 108 of a plurality of equidistantly-spaced outer grooves 108. In some examples, a distance d8 between each groove 108 of the equidistantly-spaced outer grooves 108 is approximately 3 mm. In some examples, the distance d8 is between, and inclusive of, 1.5 mm and 4.5 mm.

In some examples, the spacing d8 between outer grooves 108 is not greater than 15 percent of the distance between a gap in the baseplate 152 and the first outer groove 108. In some examples, the spacing d8 between outer grooves 108 is between, and inclusive of, 4 percent and 15 percent of the distance between a gap in the baseplate 152 and the first outer groove 108.

In some examples, a groove 108 forms an angle ϕ in the interior surface 106 of approximately 120 degrees. In some examples, the angle ϕ of each groove 108 is the same. In some examples, the angle ϕ is between, and inclusive of, 90 degrees and 150 degrees.

Referring to FIGS. 4A-4B, in some examples, the grooves are not elongated. Rather, at least one groove 108 can have a substantially conical shape. In some examples, at least one of the grooves 108 has a semi-spherical, cylindrical, cubical, rectangular, and/or triangular shape.

In some examples, the grooves 108 are arranged in a plurality of lines 112 where each line 112 includes multiple aligned grooves 108 and extends radially outward away from the axis 110 in a direction parallel to the radius d4 of the disks 115. The grooves 108 of each line 112 are equidistantly spaced in the radial direction extending outward from the axis 110. In some examples, the grooves 108 are arranged in a staggered formation. The grooves 108 of a line 112 of the plurality of lines 112 are offset radially from the grooves 108 of an adjacent line 112. In some examples, the lines 112 are equidistantly spaced in the circumferential direction. An angle ɵ between adjacent lines 112 is approximately 5 degrees. In some examples, the angle ɵ between adjacent lines 112 is between, and inclusive of, 2 degrees and 8 degrees.

FIG. 4B is a cross-sectional side elevation view of the base 130 taken along the plane ‘B’ of FIG. 4A. Referring to FIG. 4B, in some examples, a groove 108 forms an angle ϕ in the interior surface 106 of approximately 118 degrees. The angle ϕ is equal to twice an apex angle of a cone shape of the groove 108. In some examples, the angle ϕ is between, and inclusive of, 90 degrees and 150 degrees.

Referring to FIG. 5, in some examples, the grooves 108 are shaped as curved lines. For example, the grooves 108 can be substantially helical shaped with respect to the axis 110. In some examples, in a circumferential direction about the axis 110, a distance d9 from the axis 110 to each one of the grooves 108 changes. According to certain examples, a groove 108 intersects a plane ‘B’ along which the axis lies. In some examples, multiple grooves 108 intersect the plane ‘B.’ In some examples, three or more grooves 108 intersect the plane ‘B.’ In some examples, each groove 108 is shaped as part of a spiral with respect to the axis 110. Each groove 108 can be part of a line that winds around the axis 110 as a center point while the distance d9 between the groove 108 and the axis 110 increases along the groove 108. The distance d9 between the groove 108 and the axis 110 can increase from a first end 156 of the groove 108 to a second end 158 opposite to the first end 156.

In some examples, the direction of the spiral formed by at least one of the grooves 108 with respect to the axis 110 goes against the rotation of the disks 115. In some examples, the disks 115 are configured to rotate in a first direction r1, and the distance between the axis 110 and the groove 108 increases in a circumferential direction r2 different from the first direction r1. In some examples, the circumferential direction r2 is opposite to the direction r1. In some examples, one of the direction r1 and the direction r2 is substantially clockwise, while the other one of the direction r1 and the direction r2 is substantially counter-clockwise. In some examples, the direction r2 is clockwise.

In some examples, a ratio of the quantity of the disks 115 to a quantity of the grooves 108 is between, and inclusive of, 0.05 and 10. In some examples, the quantity of disks 115 is not less than 10. In some examples, the quantity of disks 115 is not greater than 13. In some examples, the quantity of grooves 108 is between, and inclusive of, 2 and 40. In some examples, the recessed portions 118 of the interior surface 106 make up not less than 20 percent of a surface area of the interior surface 106. In some examples, the recessed portions 118 make up not greater than 70 percent of the surface area.

Examples of the present disclosure include methods of forming the grooves 108 in the baseplate 152. Some methods include forming the grooves 108 in the baseplate 152 during formation of the baseplate 152. Some examples include forming the baseplate 152 with the grooves 108 using a mold or stamp with protruding portions that correspond to the grooves 108. Some examples include forming the grooves 108 by etching away material from a baseplate substrate. Some examples include machining the grooves 108 into the baseplate 152.

In the above description, certain terms may be used such as "up," "down," "upper," "lower," "horizontal," "vertical," "left," "right," “over,” “under” and the like. These terms are used, where applicable, to provide some clarity of description when dealing with relative relationships. But, these terms are not intended to imply absolute relationships, positions, and/or orientations. For example, with respect to an object, an "upper" surface can become a "lower" surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.”

The term “about” or “substantially” or “approximately”, in some embodiments, is defined to mean within +/-5% of a given value, however in additional embodiments any disclosure of “about” or “substantially” or “approximately” may be further narrowed and claimed to mean within +/- 4% of a given value, within +/- 3% of a given value, within +/- 2% of a given value, within +/- 1% of a given value, or the exact given value. Further, when at least two values of a variable are disclosed, such disclosure is specifically intended to include the range between the two values regardless of whether they are disclosed with respect to separate embodiments or examples, and specifically intended to include the range of at least the smaller of the two values and/or no more than the larger of the two values. Additionally, when at least three values of a variable are disclosed, such disclosure is specifically intended to include the range between any two of the values regardless of whether they are disclosed with respect to separate embodiments or examples, and specifically intended to include the range of at least the A value and/or no more than the B value, where A may be any of the disclosed values other than the largest disclosed value, and B may be any of the disclosed values other than the smallest disclosed value.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms "first," "second," etc. are used herein merely as labels and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

The present subject matter may be embodied in other specific forms without departing from its spirit or essential characteristics. The described examples are to be considered in all respects only as illustrative and not restrictive. All changes which come within the meaning and range of equivalency of the claims are to be embraced within their scope.

What is claimed is:

1. A base for a magnetic storage device, the base comprising:
a baseplate;
sidewalls extending from the baseplate; and
an interior cavity defined by the baseplate and the sidewalls;
wherein:
the baseplate comprises an exterior surface and an interior surface opposite to the exterior surface;
the interior surface at least partially defines the interior cavity;
the interior surface comprises a substantially planar surface and grooves formed in the substantially planar surface;
a thickness of the baseplate varies; and
a minimum thickness of the baseplate is defined by at least one groove of the grooves.

2. The base of claim 1, wherein each groove of the grooves has a substantially circular shape.

3. The base of claim 1, wherein a minimum thickness of the baseplate defined by the at least one groove is not less than 20 percent of a maximum thickness of the baseplate.

4. The base of claim 1, wherein the grooves are equidistantly spaced.

5. A magnetic storage system, comprising:
a quantity of disks configured to rotate about an axis; and
a base comprising:
a baseplate;
sidewalls extending from the baseplate; and
an interior cavity defined by the baseplate and the sidewalls and receiving the quantity of disks;
wherein:
the baseplate comprises an exterior surface and an interior surface opposite to the exterior surface;
the interior surface at least partially defines the interior cavity;
the interior surface comprises a substantially planar surface and grooves formed in the substantially planar surface;
a thickness of the baseplate varies; and
a minimum thickness of the baseplate is defined by at least groove of the grooves.

6. The magnetic storage system of claim 5, wherein the grooves extend radially outward in a direction away from the axis.

7. The magnetic storage system of claim 6, wherein at least one groove of the grooves has a length that is not less than 20 percent and not more than 90 percent of a radius of each disk of the quantity of disks.

8. The magnetic storage system of claim 5, wherein an entirety of the grooves is confined within an outer perimeter of the disks.

9. The magnetic storage system of claim 5, wherein:
each groove of the grooves has a substantially conical shape; and
the grooves are arranged in a plurality of lines, each line extending radially outward away from the axis.

10. The magnetic storage system of claim 9, wherein the grooves of a first line of the plurality of lines are offset radially from the grooves of a second line of the plurality of lines, the second line being adjacent to the first line.

11. The magnetic storage system of claim 5, wherein each groove of the grooves has a circular shape concentric with the quantity of disks.

12. The magnetic storage system of claim 5, wherein, in a circumferential direction about the axis, a distance from the axis to each groove of the grooves changes.

13. The magnetic storage system of claim 12, wherein:
the disks are configured to rotate in a first direction; and
the distance increases in a circumferential direction opposite to the first direction.

14. The magnetic storage system of claim 12, wherein at least some of the grooves intersect a plane along which the axis lies.

15. The magnetic storage system of claim 5, wherein a ratio of the quantity of disks to a quantity of the grooves is between, and inclusive of, 0.05 and 10.

16. The magnetic storage system of claim 5, wherein the exterior surface is substantially planar and groove-less.

17. The magnetic storage system of claim 5, wherein the base has a monolithic, one-piece, and seamless construction.

18. The magnetic storage system of claim 5, wherein a maximum distance between a bottom disk of the quantity of disks, closest to the baseplate, and the interior surface is not less than 0.5 mm and not greater than 2.5 mm.

19. The magnetic storage system of claim 5, wherein:
each groove of the grooves defines a recessed portion of the baseplate; and
a distance between a bottom disk of the quantity of disks, closest to the baseplate, and the interior surface at the recessed portion is greater than a distance between the bottom disk and any other portion of the interior surface.

20. A magnetic storage system, comprising:
a quantity of disks configured to rotate about an axis; and
a base comprising:
a baseplate;
sidewalls extending from the baseplate; and
an interior cavity defined by the baseplate and the sidewalls and receiving the quantity of disks;
wherein:
the baseplate comprises an exterior surface and an interior surface opposite to the exterior surface;
the interior surface at least partially defines the interior cavity; and
the interior surface comprises a substantially planar surface and a means of varying a thickness of the baseplate such that a minimum thickness of the baseplate is defined by the means of varying the thickness.
